(19) United States
(12) Patent Application Publication
(10) Pub. No.: US 2026/0138519 A1
(43) Pub. Date: May 21, 2026

(54) FASTENING DEVICE FOR LOADS ON A BOUNDARY SURFACE OF A LOADING AREA OF A MOTOR VEHICLE, AND MOTOR VEHICLE

(71) Applicant: BOS GmbH & Co. KG, Ostfildern (DE)

(72) Inventor: Mickey Alan HANNAN, Shelby Township, MI (US)

(21) Appl. No.: 19/378,602

(22) Filed: Nov. 4, 2025

Related U.S. Application Data
(60) Provisional application No. 63/722,245, filed on Nov. 19, 2024.

(51) Int. Cl. B60P 7/08; B62D 33/023

(52) U.S. Cl. CPC B60P 7/0807; B62D 33/023

(57) ABSTRACT

A fastening device for use in a loading area of a motor vehicle having a boundary surface with at least one penetration or opening. The fastening device includes a load attachment unit fixable to the boundary surface by swivelable retaining arms which project through the penetration in a fitted state. Inside the load attachment unit an actuating element is held and is mounted in the load attachment unit for movement between a blocking position and a release position. The actuating element interacts with the swivelable retaining arms such that in the blocking position of the actuating element the retaining arms are forcibly moved by the actuating element into a spread-out fixing position gripping behind a rim of the penetration, and in the release position of the actuating element the retaining arms are released for a swivel movement.

### CROSS-REFERENCE TO RELATED APPLICATION

This claims priority from U.S. Provisional Application No. 63/722 245, filed Nov. 19, 2024, the disclosure of which is hereby incorporated by reference in its entirety.

### TECHNICAL FIELD

The invention relates to a fastening device for loads on a boundary surface of a loading area of a motor vehicle, with at least one penetration in the boundary surface for fastening a load attachment unit, which is fixable to the boundary surface by means of swivelable retaining arms which project through the penetration in the fitted state. The invention also relates to a motor vehicle with such a fastening device.

### BACKGROUND AND SUMMARY

A fastening device for a loading space of a motor vehicle is known from DE 10 2007 018 254 A1. The fastening device has a load attachment unit which may be fastened to a load rail fitted firmly to the vehicle in the loading space. The load attachment unit has two swivelable retaining arms, which in their fitted state, inserted into the load rails, grip behind profile sections of a longitudinal groove of the load rail.

An object of the invention is to provide a fastening device and a motor vehicle of the type mentioned at the outset which permit particularly simple and functionally dependable securing of the load.

This object is achieved for the fastening device in that inside the load attachment unit, an actuating element is held which is movably mounted in the load attachment unit between a blocking position and a release position and which interacts with the swivelable retaining arms such that in the blocking position of the actuating element the retaining arms are forcibly moved by the actuating element into a spread-out fixing position gripping behind a rim of the penetration, and that in the release position of the actuating element the retaining arms are released for a swivel movement. The actuating element accordingly moves the retaining arms into the blocking position and permits a reset of the retaining arms into the release position. The actuating element is preferably moved linearly along a straight line or along a curved path inside the load attachment unit. Alternatively, the actuating element may be swivelably mounted inside the load attachment unit. The solution in accordance with the invention is suitable for fastening loads to boundary surfaces of a loading area of a motor vehicle. Such a loading area may be provided in a vehicle interior or also on the outside of the vehicle. A corresponding boundary surface is advantageously a wall surface of the loading area. Particularly preferably, the loading area is provided behind a vehicle occupants'cab of a pickup vehicle. A floor surface or a lateral wall surface of the pickup loading area may be advantageously provided as the boundary surface. The penetration in the boundary surface is advantageously provided as a hole or as a slot or as an otherwise designed opening in the boundary surface. The boundary surface may be provided on its rear side, i.e. facing away from the loading area, with at least one reinforcing element in order to prevent deformation or damage to the boundary surface during operation of a fitted load attachment unit.

The load attachment unit is used for the fastening of fastening elements such as straps, support rails, fastening ropes or similar fastening equipment for fixing loads. In accordance with the invention, the load attachment unit may be fitted or removed in a one-handed operation, since only the actuating element has to be moved to permit movement of the retaining arms into the fixing position or into the release position. In the release position, the retaining arms can be passed through the penetration. In the fixing position, the retaining arms are spread out, so that the retaining arms are anchored positively on a rear side of the penetration and behind a rim of the latter.

In one embodiment of the invention, the actuating element is guided in linearly movable manner along a fitting axis inside the load attachment unit between the blocking position and the release position. Advantageously, the actuating element is guided in longitudinally movable manner inside a cavity of the load attachment unit, extending over the full height of the latter. The cavity is advantageously adapted to a cross-sectional contour of the actuating element, so that the actuating element fills the cavity.

In a further embodiment of the invention, a spring device, which exerts a permanent spring force on the actuating element in the direction of the blocking position of the actuating element, is provided in the load attachment unit. The spring device is formed preferably by at least one helical Compression spring which is mounted inside the load attachment unit and which abuts against the actuating element.

In a further embodiment of the invention, the actuating element is provided, on a front side facing away from the retaining arms, with a manually actuatable control surface which in the blocking position projects out of the load attachment unit at the front. The control surface may be a front surface molded in one piece with the actuating element. Alternatively, the control surface may be formed by a touch element attached to the front side of the actuating element.

In a further embodiment of the invention, the retaining arms are joined to the load attachment unit such that the retaining arms flank the actuating element on opposite sides. The retaining arms are here preferably mirror-symmetrically swivelable relative to one another to ensure synchronous spreading or converging of the retaining arms.

In a further embodiment of the invention, the actuating element is provided, on an end face region opposite the control surface, with a controlling section widened in comparison to a guide section of the actuating element and in contact with the retaining arms. The controlling section may be designed piston-like or plunger-like. The controlling section may be a one-piece component of the actuating element or a separately manufactured component which is firmly connected to the guide section of the actuating element.

In a further embodiment of the invention, the actuating element is provided on opposite sides with bearing pins, projecting transversely to a movement axis of the actuating element, which project outwards through lateral slot guides of the load attachment unit and which support a load bracket which is swivelably joined to the bearing pins. The bearing pins have a dual function. On the one hand, they are used for swivelable mounting of the load bracket. On the other hand, they limit the linear movability of the actuating element due to their movement along the lateral slot guides, so that the actuating element cannot slip unintentionally out of the load attachment unit. The bearing pins are firmly connected to opposite longitudinal sides of the actuating element.

In a further embodiment of the invention, the actuating element has on its front region, which projects forwards beyond the load attachment unit, at least one fastening receptacle provided for fastening an attachment. A suitable fastening element, such as in particular a support rail, a strap, a fastening rope or similar, is provided as an attachment. The fastening receptacle may be provided as a recess, as a hole passing through the entire width or thickness of the actuating element, as a threaded hole or similar.

In a further embodiment of the invention, a locking arrangement, which secures the actuating element in its blocking position, is provided on the load attachment unit, and the locking arrangement is moved out of the secured position into an open position by means of a key or another handling element. The locking arrangement secures the actuating element in its blocking position so that any unauthorized detachment of the load attachment unit from the boundary surface on the vehicle side is dependably prevented. A tool, in particular a screwdriver or also a coin, may be provided as the handling element.

With respect to the motor vehicle, the motor vehicle provided is a multi-track motor vehicle that can be intended for conveying passengers and/or loads. The motor vehicle may be provided with an open loading area or with a closed loading space. The closed loading space too forms a loading area in the meaning of the invention. The closed loading space is advantageously part of a vehicle interior. The closed loading space may also be part of a superstructure of a truck. The term motor vehicle covers trucks, commercial and passenger vehicles.

Further advantages and features of the invention are revealed by the claims and by the following description of preferred examples of the invention which are explained with reference to the drawings.

### BRIEF DESCRIPTION OF THE DRAWINGS

FIG. 1 shows in a perspective view a load attachment unit for an embodiment of a fastening device in accordance with the invention;

FIG. 2 shows schematically in a perspective view a part of a motor vehicle in the form of a pickup vehicle, with several penetrations in a loading area for fastening load attachment units according to FIG. 1;

FIG. 3 shows schematically in a side view an embodiment of a fastening device in accordance with the invention, with a load attachment unit according to FIG. 1 and with a boundary surface of a loading area according to FIG. 2;

FIG. 4 shows schematically a sectional view of the fastening device according to FIG. 3 in a release position;

FIG. 5 shows the view according to FIG. 3, but in a fixing position of the load attachment unit;

FIG. 6 shows schematically in a sectional view the fixing position of the fastening device according to FIG. 5;

FIG. 7 shows in a perspective view the fastening device according to FIGS. 1 and 3 to 6 with a support rail additionally mounted on the load attachment unit;

FIG. 8 shows a securing pin for fastening the support rail to the load attachment unit according to FIG. 7;

FIG. 9 shows schematically a plan view onto the fastening device according to FIGS. 5 and 6 with a load bracket in a horizontal position;

FIG. 10 shows schematically a side view of the fastening device according to FIG. 9, but with the load bracket in an upwardly vertical position;

FIG. 11 shows a view according to FIG. 10, but with the load bracket in a downwardly vertical position;

FIG. 12 shows an exploded view of the load attachment unit according to FIG. 1;

FIG. 13 shows a further version of a load attachment unit similar to FIG. 1;

FIG. 14 shows a perspective exploded view of a locking arrangement for the load attachment unit according to FIG. 13;

FIG. 15 shows a section of the load attachment unit according to FIG. 13 with key inserted into the locking arrangement; and

FIG. 16 shows a section of the load attachment unit similar to FIG. 15 with a modified locking arrangement which can be operated with a handling element in the form of a coin.

### DETAILED DESCRIPTION

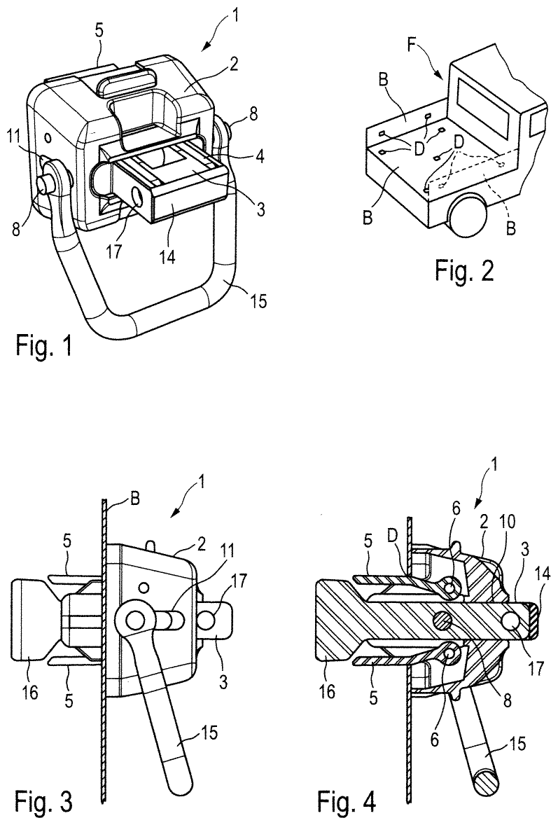

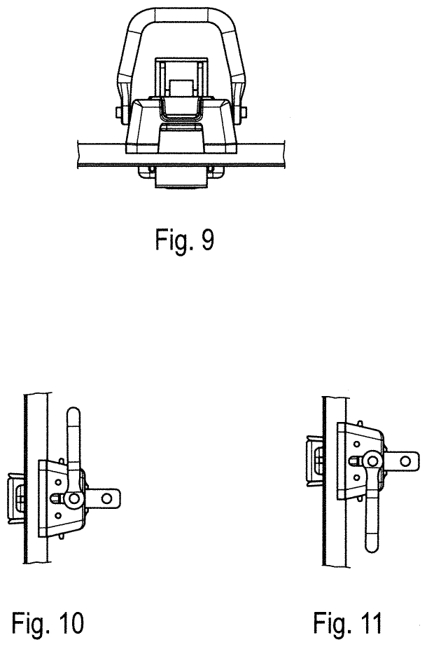

A motor vehicle F in the form of a pickup vehicle according to FIG. 2 has in a rear section a loading area B, also referred to as a loading bed. The loading area is limited by boundary surfaces B, which comprise a loading floor and two lateral loading walls. In the schematic view according to FIG. 2, all three boundary surfaces B have in the boundary surfaces several penetrations D designed as cutouts in the respective boundary surface B. The boundary surface B is reinforced such that no deformation of the boundary surface B results even when a fastening device is fitted in the loading area for fastening of loads. A corresponding fastening device in the meaning of the invention has at least one load attachment unit 1, which is described in more detail on the basis of FIGS. 1 and 3 to 12. This load attachment unit 1 is fitted in a corresponding penetration D of the loading area of the motor vehicle F in a manner described in more detail in the following. The load attachment unit 1 may be removed again when not needed.

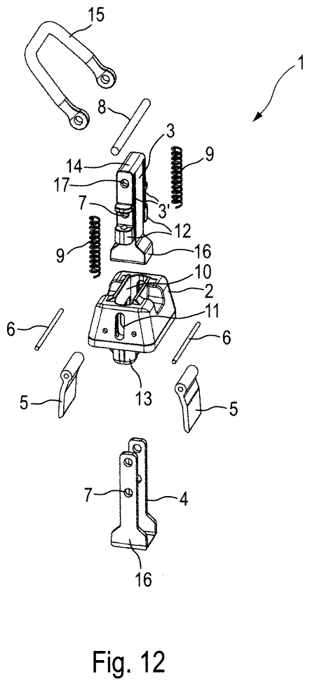

The load attachment unit 1 has, as may be readily seen in FIG. 12, a carrier housing 2, which in the example shown consists of plastic. An actuating element 3, 4 is guided in longitudinally movable manner inside the carrier housing 2. The carrier housing 2 has for that purpose a cavity 10, open on opposite sides, inside which the actuating element 3, 4 is guided in longitudinally movable manner. The actuating element 3, 4 is designed in two parts. The actuating element has a plastic body 3 of plunger-like design. Two longitudinal slots 3′, into which a reinforcing bracket 4 with two plate-like bracket sides is inserted, are provided inside the plastic body 3. The two bracket sides are connected to one another at the bottom to form one piece by a transverse piece. The reinforcing bracket 4 is made from sheet steel. As can be readily seen from FIG. 12, the actuating element 3, 4 has a substantially cuboid guide section, adjoined by a plunger-like or piston-like widened portion 16 towards a rear side. The cuboid guide section is guided in longitudinally movable manner along a fitting axis of the load attachment unit 1 by the walls of the cavity 10. The actuating element 3, 4 projects out of the carrier housing 2 at both a front side and the rear side. The part projecting at the rear side is the widened portion 16. The section projecting at the front side is an end face region on which is provided a control surface 14 which serves to exert a manual pushing movement on the actuating element 3, 4. The actuating element 3, 4 is provided in the region of the guide section with a transverse hole 7 which extends over an entire width of the guide section. A bearing pin 8, which projects out of the actuating element on opposite sides, is passed through this transverse hole 7. Its opposite end face regions are guided slidingly in slot guides 11 of the carrier housing 2, so that a longitudinal movability of the actuating element 3, 4 is limited to the length of the two slot guides 11 on opposite sides of the carrier housing 2. The end face regions of the bearing pin 8 also project outwards out of the carrier housing 2 beyond the slot guides 11. These end sections are used to fasten a U-shaped load bracket 15 to the bearing pin 8, so that the bearing pin 8 serves as a swivel axis for the load bracket 15.

A spring load of a spring device, which is formed by two helical compression springs 9 in the example shown, acts permanently on the actuating element 3. The two helical compression springs 9 flank the actuating element 3, 4 on opposite sides. The two helical compression springs 9 abut at the rear a receiving section 13 of the carrier housing 2 and extend parallel to the fitting axis, and hence also parallel to the movement direction of the actuating element 3, 4. The two helical compression springs 9 each abut a bottom of the receiving section 13 of the carrier housing 2 at the rear and a supporting shoulder 12 of the actuating element 3, 4 at the front. The supporting shoulders 12 project from the actuating element 3, 4 transversely to the fitting axis, wherein the supporting shoulders 12 are designed as plastic sections molded on in one piece. The end faces of the helical compression springs 9 at the front side abut these supporting shoulders 12, so that the actuating element 3, 4 inside the carrier housing 2 is permanently spring-loaded in the direction of the front side of the carrier housing 2.

Two retaining arms 5 are also swivelably mounted in the carrier housing 2. Each retaining arm 5 is swivelably mounted in the carrier housing 2 by means of an axle pin 6. The two axle pins 6 are inserted into corresponding axle receptacles, not described in detail, of the carrier housing 2. Both retaining arms 5 flank the actuating element 3, 4 with a 90°offset to the helical compression springs 9 in the carrier housing 2, and project outwards at the rear side of the carrier housing 2. The axle pins 6 form, for both retaining arms 5, swivel axes which are aligned parallel to the swivel axis formed by the bearing pin 8. The axle pins 6 form hinge pins for the retaining arms 5, wherein the retaining arms 5 extend from these axle pins 6 out of the carrier housing 2 at the rear side.

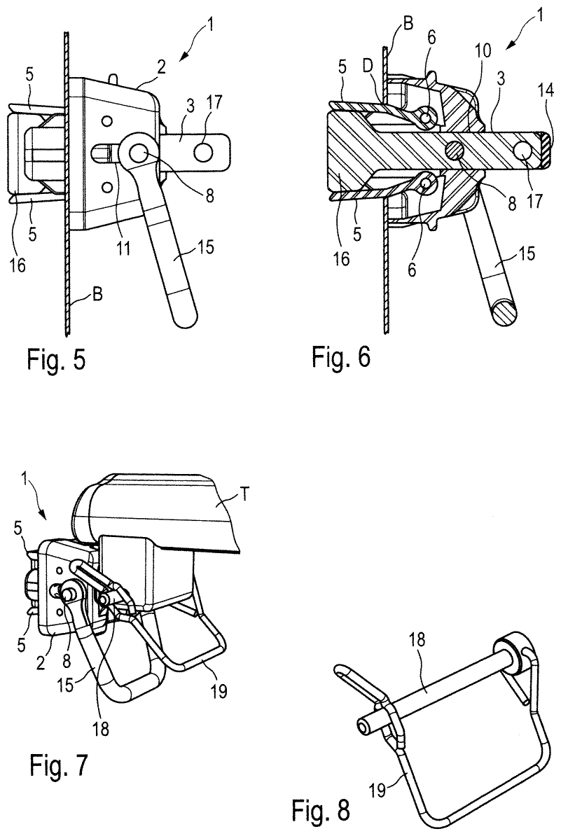

As may be readily seen in FIGS. 3 to 6, the retaining arms 5 flank the actuating element 3, 4 such that during a linear movement of the actuating element 3, 4 the plunger-like widened portion 16 comes into contact with the two retaining arms 5 simultaneously. Both retaining arms 5 are designed mirror-symmetrical, but otherwise identical to one another. Both retaining arms 5 move synchronously outwards as soon as the actuating element 3, 4 is moved out of a rear release position (FIGS. 3 and 4) into a front blocking position (FIGS. 5 and 6). Due to the permanent pressure of the helical compression springs 9, the actuating element 3, 4 is held permanently in the blocking position without an opposing manually applied load, so that the widened portion 16 spreads the retaining arms 5 outwards. As soon as an opposing pressure is exerted on the control surface 14 by an operator, the widened portion 16 moves toward the rear of the carrier housing 2, and thereby the widened portion 16 moves out of contact with the retaining arms 5. The penetration D in the boundary surface B is matched to the distance of the retaining arms 5 from one another, such that in the release position of the actuating element 3, 4 the carrier housing 2 can, together with the retaining arms 5, pass through this penetration D.

It may be seen from FIGS. 1 to 8 that the actuating element 3, 4 also has, at the front on its front section adjoining the control surface 14 and permanently projecting forwards out of the carrier housing 2, a receiving hole 17 aligned parallel to the transverse hole 7 in the actuating element 3, 4 and open at opposite sides of the actuating element 3, 4. This receiving hole 17 is used as the fastening receptacle for a securing pin 18, which can be used to fasten a support rail T to the actuating element 3, 4 and hence to the load attachment unit 1. A bracket-like loss preventer 19 is associated with the securing pin 18, as may be readily seen in FIGS. 7 and 8.

The mounting of the bearing pin 8 in the carrier housing 2 and in the actuating element 3, 4, and the load bracket 15, are used for absorbing loads and for transmitting loads to the load attachment unit 1 and in the fitted state to the penetration D of the respective boundary surface B. The various functional components are designed here such that tensile forces of up to 5000 N acting on the load bracket 15 cannot detach an anchoring of the load attachment unit 1 in the respective penetration D. Maximum tensile forces for the normal loading case of securing loads on the loading area of the motor vehicle F are however less than that. Tensile forces acting on the load bracket 15 against the fitting direction should not exceed 1100 N. Tensile forces acting on the load bracket 15 parallel to the swivel axis of the load bracket 15 should not exceed 2232 N. Preferably, maximum tensile forces in a plane parallel to the boundary surface B should be at most 890 N when the load attachment unit 1 is fitted. A stiffening plate on the boundary surface B at least in the region of the respective penetration is an essential condition for these tensile force limit values.

For its practical operation, the fastening device has several load attachment units 1 and corresponding fastening elements that can be fixed to the load brackets 15 of these load attachment units 1. Fastening elements of this type can also be straps or similar in addition to a support rail T according to FIG. 7.

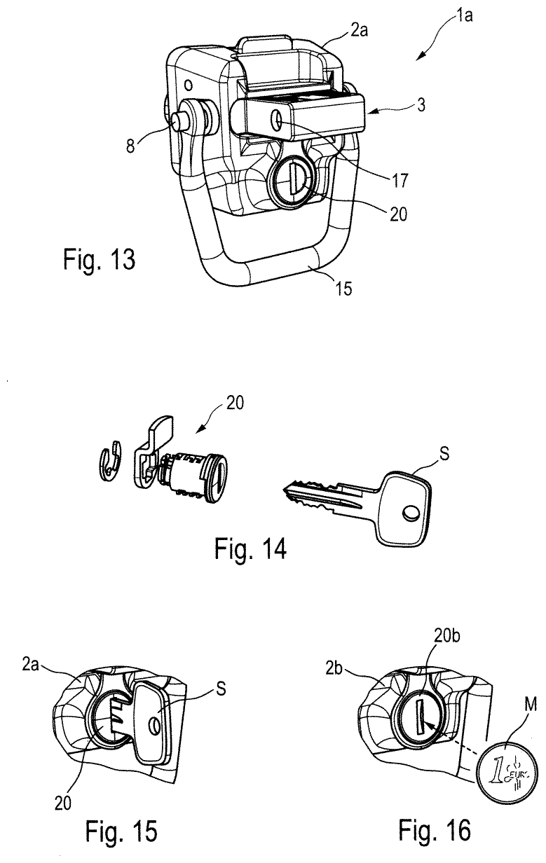

The load attachment unit la according to FIGS. 13 to 15 corresponds in its function and construction to the load attachment unit 1 as described previously. Identical functional components of the load attachment unit la are therefore provided with the same reference numerals as used for the load attachment unit 1. The following deals only with the differences of the load attachment unit 1a. As can be seen in FIG. 13, the load attachment unit la has a slightly modified carrier housing 2a. The guidance and support of the actuating element 3, the design of the load bracket 15 and the mounting of the bearing pin 8 in corresponding slot guides are designed identically. However, the carrier housing 2a additionally has a locking arrangement 20 that blocks the actuating element 3, 4 in the blocking position. To do so, the locking arrangement 20 according to FIG. 14 has a swivelable cam which, depending on a position of a lock cylinder in the locking arrangement 20, moves into a blocking slot, not shown, of the actuating element 3 or releases this blocking slot. A key S is used to operate the lock cylinder and hence to swivel the locking cam. In the blocked position, a linear movement of the actuating element 3 is prevented by the locking arrangement 20, so that in the fitted state of the load attachment unit la the load attachment unit 1 cannot be removed from the boundary surface B and hence from the penetration D.

A carrier housing 2b according to FIG. 16 corresponds substantially to the embodiment according to FIGS. 13 to 15, so that reference is made to the statements relating to the load attachment unit la according to FIGS. 13 to 15 in order to avoid repetition. A crucial difference is that the lock cylinder of the locking arrangement 20b according to FIG. 16 may be operated not by a key S, but by another handling element, in the present case by a coin M. By simply inserting the coin M into a slot of the lock cylinder in the locking arrangement 20b, the locking cam can be swiveled between the blocking position and the open position.

1. A fastening device for loads on a boundary surface of a loading area of a motor vehicle, the boundary surface having at least one penetration, the fastening device comprising:
for fastening a load attachment unit having swivelable retaining arms for fixing the load attachment unit to the boundary surface, the swivelable retaining arms projecting through the penetration in a fitted state;
an actuating element disposed inside the load attachment unit, the actuating element being movably mounted in the load attachment unit for movement between a blocking position and a release position and the actuating element interacting with the swivelable retaining arms such that in the blocking position of the actuating element the swivelable retaining arms are forcibly moved by the actuating element into a spread-out fixing position gripping behind a rim of the penetration, and in the release position of the actuating element the retaining arms are released for a swivel movement.

2. The fastening device according to claim 1, wherein the actuating element is guided in linearly movable manner along a fitting axis inside the load attachment unit between the blocking position and the release position.

3. The fastening device according to claim 1, further including a spring device disposed in the load attachment unit and exerting a permanent spring force on the actuating element in a direction of the blocking position of the actuating element.

4. The fastening device according to claim 1, wherein the actuating element, on a front side facing away from the retaining arms, includes a manually actuatable control surface, the control surface in the blocking position projecting out of the load attachment unit at a front thereof.

5. The fastening device according to claim 1, wherein the retaining arms are joined to the load attachment unit such that the retaining arms flank the actuating element on opposite sides thereof.

6. The fastening device according to claim 4, wherein the actuating element, on an end face region opposite the control surface, includes a controlling section widened in comparison to a guide section of the actuating element and in contact with the retaining arms in the blocking position of the actuating element.

7. The fastening device according to claim 1, wherein the actuating element includes on opposite sides thereof at least one bearing pin, the load attachment unit including a load bracket and lateral slot guides, the at least one bearing pin projecting transversely to a movement axis of the actuating element and outwards through the lateral slot guides of the load attachment unit, and in that the at least one bearing pin supports the load bracket, the load bracket being swivelably joined to the at least one bearing pin.

8. The fastening device according to claim 1, wherein the actuating element has on a front region projecting forwards beyond the load attachment unit, the front region having at least one fastening receptacle provided for fastening an attachment.

9. The fastening device according to claim 1, wherein the load attachment unit includes a locking arrangement securing, the actuating element in the blocking position, and the locking arrangement is movable out of a secured position and into an open position by a key or other handling element.

10. A motor vehicle, comprising:
a loading area with a boundary surface, the boundary surface defining therein at least one penetration; and
a fastening device, the fastening device comprising:
a load attachment unit having swivelable retaining arms for fixing the load attachment unit to the boundary surface, the swivelable retaining arms projecting through the penetration in a fitted state; and
an actuating element disposed inside the load attachment unit, the actuating element being movably mounted in the load attachment unit for movement between a blocking position and a release position and the actuating element interacting with the swivelable retaining arms such that in the blocking position of the actuating element the swivelable retaining arms are forcibly moved by the actuating element into a spread-out fixing position gripping behind a rim of the penetration, and in the release position of the actuating element the retaining arms are released for a swivel movement.
